(19) United States
(12) Patent Application Publication
(10) Pub. No.: US 2010/0070566 A1
(43) Pub. Date: Mar. 18, 2010

(54) System and Method for Deploying Customised Web Applications

(76) Inventor: Jean-Jacques Vandewalle, Lille-Hellemmes (FR)

Correspondence Address: BUCHANAN, INGERSOLL & ROONEY PC, POST OFFICE BOX 1404, ALEXANDRIA, VA, 22313-1404, US

(21) Appl. No.: 12/438,693

(22) PCT Filed: Dec. 20, 2006
(86) PCT No.: PCT/EP06/69966

§ 371 Date: Oct. 6, 2009

(30) Foreign Application Priority Data
Dec. 29, 2005 (FR) 0513467

(51) Int. Cl. G06F 3/01; G06F 15/16

(52) U.S. Cl. 709/203; 715/745; 715/760

(57) ABSTRACT

A method for customising a Web application executed on a user's terminal by means of a browser provided thereon, upon a request transmitted from the browser via a telecommunication network to a remote Web server hosting the application. At least one customising program and/or customising data is hosted by a local server belonging to a user assigned to the terminal. The application is customized by mixing the customising program and/or customized data items delivered by the local server with data items related to the application corresponding to the processing of the request transmitted by the remote server.

The present invention relates to the architecture and deployment of customised web applications.

A Web application is typically presented in the form of HTML (acronym for HyperText Markup Language) or XHTML (reformulation of HTML 4 into XML) pages, originating from a Web server and being executed in a browser on the client terminal of the user.

The user is therefore able to interact with the application passing from one page to another by clicking on the hypertext links or by filling out forms. Said actions correspond to a request sent to the Web server via the browser according to the protocol of the Web, i.e. HTTP (acronym for HyperText Transport Protocol). The server decodes and executes the request, then returns, always via the HTTP protocol, a new HTML page which corresponds to the result of the execution of the request. Said page is therefore displayed by the browser and the user can consult same and continue to interact with the application from said new page.

The architecture enabling such applications to be deployed is therefore adapted to the request-response model and to the HTML presentation format, i.e. that an application coming from a Web server decodes the requests, executes the processings for calculating the data of the response, formats said responses in the HTML format, and sends the final page to the requester, i.e. the Web browser installed at the level of the client terminal of the user.

The deployment of a Web application thus consists of installing the program thereof on a Web server, which will manage exchanges of messages according to the HTTP format, and quite often interconnecting said application with the databases wherein the application will be able to draw on the data to be presented.

The customisation of a Web application consists of making said application the best suited to the requirements and features of each user, for example proposing to same fast access to the functions that he carries out the most often, enabling same to automate certain process follow ups, presenting to same a man-machine interface (MMI) which corresponds to the preferences thereof, etc.

In said context, the known solutions for customising Web applications are the following (not being mutually exclusive, they may multiply):

the integration of a customisation program in the program of the application itself. Said generic customisation program is therefore envisaged to be executed by the application program on the Web server during each HTTP request processing (decoding and execution) received from a user via the browser thereof. The effect of such a customisation program on the processing of the request is therefore to potentially modify the nature or adapt the format of the results of the execution of the request;

the use of diversified customisation programs by the program of the application (according to the users or, more generally, the user profiles). Said diversified customisation programs are therefore selected in order to be executed with the application (as described in the previous point) according to the user (or the profile thereof) having transmitted the request;

the storage of customisation data in a “Users” database, which is consulted by the customisation program in order to perform the specific processings thereof, i.e. processings which will potentially modify the nature or adapt the format of the results. Said database may be deployed on the same server as the Web application or on a remote server that can be accessed via the HTTP protocol or any other protocol;

the recovery of the customisation data in the form of cookies, stored and supplied by the Web browser of the client terminal or even via “session data”, supplied by the Web application and stored in the form of parameters, which are repeated in each request from the browser.

Said customisation solutions therefore make it possible to format, at the level of the Web server of the application, HTML pages corresponding as best as possible to the uses and preferences of the user.

By way of example, if a Web application offers around ten functionalities (for example, via a list of hypertext links) and that the user only uses generally three thereof, the customisation program of the application may consist of ordering the access to said ten functionalities the most at least used by the user. This may be carried out by saving in the “Users” database one counter per functionality, which is incremented each time that the user uses a functionality. The customisation program, integrated into the program of the application on the Web server of the application, consults said list of counters, sorts same and integrates same in an ordered manner into the page of results which is returned by the Web application to the browser of the user terminal. Said customisation program must also maintain said list of counters, i.e. incrementing the counter corresponding to the functionality which has just been requested by the user.

The architecture which has just been described enabling the construction of a customised Web application is therefore characterised by a strong coupling with the technical means enabling the application itself to be constructed.

The deployment thereof is indeed entirely integrated into that of the application when the customisation program is generic. It may simply be necessary to request the management of a “users” database as seen previously. If the customisation programs are diversified, it is therefore necessary to deploy said programs for example in the “Users” database, which nevertheless involves modifying the architecture of the Web application, in particular for managing the availability of said programs.

In addition, the Web server envisaged for executing, upon a request, the program of the application, must also execute the customisation program in order to produce the final customised page requested before serving same to the client terminal.

The result of the above is that the management of the customisation programs and data has the same general features in particular in terms of availability, upgradability, adaptability and security, as those linked to the management of the application itself.

The architecture of a customised web application such as it is currently presented is essentially monolithic and offers few facilities and guarantees regarding the fact that the customisation is available for the user everywhere, nor to the fact that it may change (to be upgraded or simplified) independently of the application, nor to the fact that it may be adapted to the contents of the application and to the environment wherein the application is executed (for example a work station or a mobile telephone), nor even to the fact that the private data of the user required for the customisation is protected.

The present invention aims to solve one or more of said disadvantages, by proposing the implementation of customised web applications mainly ensuring the decoupling of customisation data and programs in relation to the application parts originating from the Web server.

With this aim in view, the subject matter of the invention is a method for customising a Web application, envisaged to be executed on a terminal of a user by means of a browser which is provided on the terminal, upon a request sent via a telecommunication network from the browser to a remote Web server hosting the application, characterised in that it comprises:

the hosting of at least one customisation program and/or customisation data by a local server belonging to the user associated to the terminal and

the implementation of the customisation of the application by mixing the customisation program and/or customisation data supplied by the local server with the data relating to the application corresponding to the processing of the request supplied by the remote server.

According to one embodiment, the local server belonging to the user is produced in the form of a Web server embedded in a portable digital device connected to the terminal of the user.

According to another embodiment, the local server belonging to the user is installed on the terminal of the user.

According to one embodiment, the step for mixing the data relating to the Web application with the customisation program and/or the customisation data is performed in the browser of the terminal of the user by means of which the application is executed.

According to said embodiment, the mixing step comprises:

the prior recovery by the browser of the data relating to the application corresponding to the processing of the request sent to the remote server,

the execution by the browser of customisation operations corresponding to the customisation program and/or to the customisation data accessed upon a request at the local server belonging to the user and

the interpretation by the browser of the results of the customisation operations for integrating same into the data relating to the application.

According to another embodiment, the step for mixing the data relating to the Web application with the customisation program and the customisation data is performed in the remote server.

According to said other embodiment, the mixing step comprises:

the supply by the remote server to the local server of data relating to the application corresponding to the processing of the request sent by the browser to the remote server,

the execution by the local server of customisation operations upon a request by the remote server and

the interpretation by the server of the results of the customisation operations for the integration thereof with the data relating to the application to be supplied to the browser of the terminal of the user.

Advantageously, the access to the customisation data and/or program(s) on the local server is secured.

Preferably, the securing of the access to the local server comprises authentication of the user.

The invention also concerns a system for customising a Web application, comprising a terminal of a user equipped with a browser comprising means for sending a request according to a data transfer protocol to a remote server hosting the application and means for receiving and executing on the terminal of the user the result of the processing of the request by the remote server, said system being characterised in that it comprises a local server belonging to the user associated to the terminal, hosting at least one program for customising the application and/or data for customising the application, and means for mixing the Web application supplied by the remote server with the customisation program and/or the customisation data hosted on the local server belonging to the user.

According to one embodiment, the mixing means are integrated into the browser of the terminal.

According to another embodiment, the mixing means are integrated into the remote server.

Preferably, the local server comprises a Web server embedded on a portable digital device connected to the terminal of the user.

Advantageously, the portable digital device comprises means for securing the access to the program(s) and/or data hosted by the embedded server.

Preferably, the portable digital device is a smart card.

The invention also relates to a portable digital device comprising an integrated Web server provided for communicating with a client according to a data transfer protocol, characterised in that the integrated server hosts at least one program and/or the customisation data of an application hosted by a remote applications server and comprises means for providing an access to the customisation data and/or program(s) of the application upon a request from the client.

Advantageously, the integrated server communicates with a browser of a terminal of a user acting as a client, by means of which the application is executed on the terminal of the user.

Preferably, the device comprises means for securing the access to the customisation data and/or program(s) of the application.

Preferably, the device is a smart card.

Other features and advantages of the present invention will emerge more clearly from reading the following description given as an illustration in a non-limiting manner and referring to the drawing appended wherein:

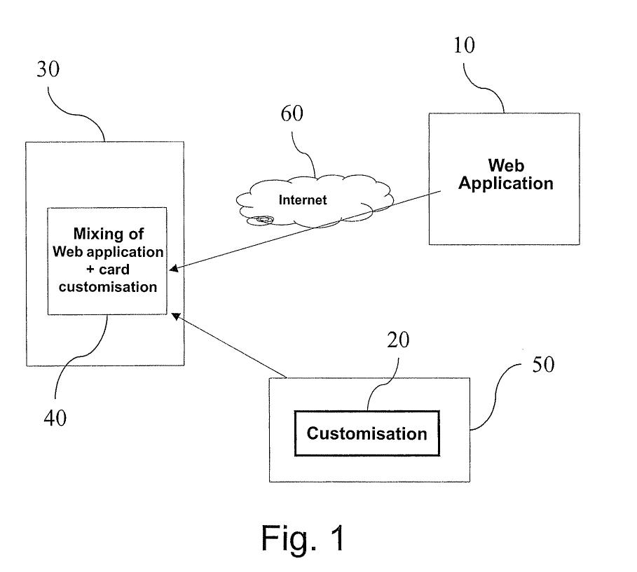

FIG. 1 illustrates the architecture of a system enabling the implementation of customised web applications according to the invention.

As illustrated in FIG. 1, the system according to the invention enabling the deployment of customised Web applications comprises the terminal 30 of the user (mobile telephone, PDA, PC, type, etc.), provided with a browser 40 for sending a request, typically according to the http protocol via the Internet network 60, to a remote Web server 10 hosting the application. The browser 40 of the user terminal also comprises means for receiving and executing on the terminal, the results of the processing of the request by the remote server, in order to display the corresponding page and thus to enable the user to continue interacting with the application from the page displayed.

The system according to the invention mainly consists of providing means enabling customisation of the requested Web application to be implemented, such that it is thus the best suited to the specific requirements and features belonging to the user, by constructing the customised Web application as an application mixing (or aggregating) the parts of the application originating from the remote Web server 10 and others, i.e. the parts relating to the customisation data and programs of the application, originating from a local Web server 20 belonging to the user, associated to the terminal of the user.

Thus, with the aid of the system of the invention, the customisation programs and data specific to each user of the application are deployed and hosted at the level of the Web servers specific to each user, rather than in the centralised database present on the Web server of the application, as is conventionally the case. Said feature, as will be seen in the following pages, enables a decoupling to be obtained in the deployment and implementation of customised Web applications, in as much as the processings linked to customisation can be advantageously decoupled from the processings carried out by the Web server of the application in order to construct upon a request a page of the application.

According to one preferred embodiment, the Web server 20 specific to each user, envisaged for hosting the customisation program(s) as well as the customisation data of the application belonging to the user, is produced in the form of a Web server embedded in a portable digital device 50, such as a smart card, an intelligent MMC (“Multimedia Card”) card, an intelligent USB (“Universal Serial Bus”) key or a mobile telephone for example.

Said embodiment therefore imposes the user, holder of the card 50 integrating the local Web server 20 and desiring to implement the customisation of an accessed application, to connect the card 50 thereof to the host terminal 30 by means of which he accesses, via the browser, the application supplied by the remote Web server 10. In a manner known in itself, the low level data transfer protocol (type T=O, T=I, USB, MMC.) between the terminal and the smart card integrating the local server is specific to said type of connection between a terminal and a card and the terminal is provided with a communication tool specific to the protocol. For all of the other layers of the transfer protocol (IP, TCP, HTTP/FTP/etc.), it involves standard protocols of the Internet enabling the host terminal 30 to communicate with the card 50 as with an ordinary server.

The portable device 50 is preferably provided with means for securing the access to the data hosted on the integrated server thereof, for example means for authenticating the user holder of the device, in order to authorise access only if the user the customisation data of whom are hosted on the local server is recognised.

In said architecture, the remote Web server 10 therefore supplies the Web application, whereas the portable device 50, via the embedded Web server 20 thereof, is provided for supplying the customisation programs as well as the customisation data of the application.

The implementation of the customisation of the application is therefore carried out via mixing (or aggregating) the customisation program and the customisation data supplied by the embedded local server 20 with the data relating to the application supplied by the remote server 10 and corresponding to the processing of the request transmitted by the browser of the user terminal for accessing a page of the application. The embodiment of the mixing between the Web application and the customisation will be described in more detail later in the description.

At this stage, it can already be noted that the advantages which are derived from the previously described architecture meet the objectives targeted by the present invention. In particular, the architecture described enables the deployment of programs and customisation data to be decoupled from the deployment of the Web application in the remote server thereof, since here the portable device of the user is used as a local server of the customisation data and programs. Said architecture advantageously enables the application to operate even in the absence of customisation, and changes the customisation without necessarily modifying the processings carried out by the server.

Moreover, in availability terms, the act of distributing and deploying customisation data and programs in portable digital devices specific to each user enables the customisation to be made available everywhere for the user, or even the customised application is available everywhere.

For the same reasons, the proposed architecture will make it possible to change and adapt the customisation with a great deal of flexibility, since the customisation data and programs relating to the application are no longer directly linked to the processings carried out by the server. In particular, the customisation will be able to change, in order to be upgraded or simplified, independently from the application, but also be able to adapt, by being for example more or less rich, to the contents of the application on one hand, and to the environment wherein the application is executed on the other hand, for example in order to take account of whether it concerns a work station or a mobile telephone.

The use of a Web server belonging to the user embedded on a portable digital device also makes it possible to make sure, by providing specific securing means on the device, that the private data of the user required for the customisation are protected.

As additional advantages, the independence in relation to the host terminal used by the user can be cited (telephone, PDA, PC, etc.).

According to one variant, it may be envisaged to install the Web server belonging to the user hosting the customisation data associated to the user, directly on the host terminal of the user, to the detriment however of the last advantage cited.

The embodiment of the mixing between the Web application originating from the remote Web server and the customisation originating from the local server belonging to the user will now be described in more detail.

A first mixing mode is to have the customisation program executed by the card 50, upon a request by the remote server 10. More specifically, the remote server 10 serves the pages of the Web application requested, and requests to the Web server 20 of the card 50 of the user the customisation operations the results of which are interpreted by the remote server 10 in order to be integrated into the final page returned by the remote server. Said embodiment where the mixing is carried out via the remote server however requires the card to be remotely accessible from the remote server by means of the telecommunication network and further has the disadvantage of loading down the work load of the application servers.

Also, a preferential embodiment consists of performing the mixing of the application parts originating from the remote application server 10 and the parts relating to the customisation originating from the local server 20, locally via the browser 40 of the user terminal 30 by means of which the application is accessed.

The advantages deriving from said mixing mode via the browser are that the customisation data and programs are always accessible from the browser of the user and therefore do not need to be remotely accessible by the server of the application.

Moreover, by completely relieving the remote Web server of the customisation function of the application by carrying out the mixing operations locally via the browser of each user, the work load of the remote server providing the application is advantageously lightened.

More specifically, the mixing mode via the browser of the host terminal is based on the technologies of the Web which enable richer, more reactive and more dynamic Web applications to be constructed. Said advanced applications enable the user to have a Web application which is no longer presented as a succession of HTML pages (for example, due to “clicks” on the links) but as real office applications having an interface (or a main, or even single “page”) which is modified during the actions of the user. Apart from the requests to the remote Web server resulting in a new HTML page, within the context of advanced Web applications, the actions of the user will have the following possible consequences:

having locally executed (i.e. in the browser) a program included in the main page of the application which may itself update the elements of said page without requiring a completely new page from being supplied by the server and reloaded by the browser;

requesting, possibly asynchronously (i.e. in the background and without blocking the flow of the operations of the user), to the remote server data applications (and not a completely new page) which may be operated by a JavaScript program of the page for updating again the elements of said page.

All of the technologies used for producing said more advanced Web applications and which in particular enable the above described operations to be carried out is often grouped under the name AJAX.

Said technologies are mainly the following:

JavaScript, as the language for the program included in the HTML pages which is executed by the browser;

DOM for “Document Object Model” and CSS for “Cascading Style Sheet”, which respectively define the structuring elements of the page (the tags defining the semantic of text portions as well as said portions themselves) and the styles via which the elements of the page are formatted (the presentation rules). DOM and CSS are both manipulable by programs written in JavaScript;

XMLHttpRequest, which is a programming interface (or API) available in JavaScript enabling HTTP requests to be executed synchronously or asynchronously towards a Web server and this in the background, i.e. without the browser loading the results to said request as a new HTML page to be displayed. The results of said request, often but not necessarily expressed in XML, are then manipulable by the JavaScript program;

GreaseMonkey UserScript, which are programs in extended JavaScript installed in the Web browser supporting the GreaseMonkey extension (such as Mozilla or Firefox for example), said programs are activated during loading of the predefined HTML pages and carry out modifications on the contents or the presentation of said page by the browser.

Said various implementation methods are called “design patterns” and most are described on the “AJAX Patterns” site.

The mode for mixing the Web application with the customisation data and programs in the browser of the user is therefore based on one hand, on the use of a Web server specific to each user, embedded in a portable digital device such as a smart card and hosting the customisation data and programs of the user and, on the other hand, on the technologies and patterns previously described for executing the customisation programs and incorporating the results thereof as well as the customisation data on the pages of the application displayed by the browser.

Said mixing enables customised Web applications to be produced in a decoupled manner, irrespective of whether said Web applications are advanced or not.

The decoupling obtained therefore makes it possible, with the benefit of the previously mentioned advantages, to mix ex-post in the browser, the generic Web application supplied by the remote application server with the specificities of the customisation belonging to the user supplied by the local server. Ex-post mixing means that the mixing is carried out after the generic data relating to the application is supplied to the browser by the remote server. Said type of ex-post mixing is thus the opposite of ex-ante mixing, i.e. carried out before the application is supplied to the browser, deriving from the previously described embodiment where the mixing is carried out via the remote Web server of the generic application.

Various executions of the mixing in the browser are possible according to the AJAX technologies implemented. It is important to note the said technologies may be combined in various ways, according to the application types, the required results or desired features and performances. Within the context of the customisation of Web applications via mixing in the browser and the use of a portable device integrating a Web server hosting the customisation data and programs, three examples of embodiment, not at all limiting, are supplied hereafter.

The first example relates to implementing the customisation of the application via the UserScripts supplied by a portable device, for example a smart card, and via requests to the card transmitted by the browser.

In said example of embodiment, the customisation data and programs are therefore UserScripts stored at the level of the card of the user and are accessible via the Web server integrated into the card. According to the example, via modification of the GreaseMonkey extension, the UserScripts of the card can be installed and saved in the browser of the user. For example a RegisterPersonalUserScript operation is added to GreaseMonkey. The user activates said operation, same connects to the Web server of the card of the user, said card connected to the host terminal. In order to reinforce the security, the connection to the local server of the card can be performed with the authentication data of the user supplied by said latter, such as to only authorise connection to the server if authentication has succeeded. The operation therefore installs the UserScripts in the browser. The UserScripts supplied by the card are accompanied by Web page address diagrams whereon they are applied and saved with same in GreaseMonkey.

Henceforth, when the user accesses a Web page the address of which corresponds to a saved address diagram, the corresponding UserScript is mixed with the application in the browser by being executed and thus carrying out customisation of the page of the application according to the operations which are encoded therein. In addition, said UserScript can send requests to the Web server of the card (for example, via XMLHttpRequest), for dynamically recovering the customisation data belonging to the user, which are used for carrying out the customisation of the page. Access to said data can also be secured via authentication of the user or via diversification of the access keys to the data specific to the session in progress. Said data can be formatted in XML or any other format that the code of the UserScript expects to process.

The UserScript can not only retrieve the data from the card of the user but can also retrieve the data from other Web servers on the network. Said UserScript can also download from the card of the user JavaScript programs via the “On-demand JavaScript” design pattern.

A second example of embodiment is supplied concerning customisation via JavaScript programs supplied by the card and/or via requests to the card.

In said example of embodiment, the HTML page of the application supplied by the remote Web server, contains requests for loading JavaScript programs to the card. Such a request is written in the page of the application via a standard directive of the HTML language. For example, the page of the “appli_{—}1” application contains the directive given below as an example, which will request the loading with the local Web server of the card of the perso.js script, said script containing for example the customisation program in the form of a single function called personalize ( ) A multitude of functions can nevertheless be contained in the customisation script and the customisation program itself can be supplied in the form of a plurality of scripts containing each of the functions.

...
<head>

...
<script type = “text/javascript” src =

“http: //card/appli_l/perso.js”></script>

...
</head>
...

When the page of the application is loaded by the browser of the user from the remote server, it is interpreted by the browser which executes the requests for loading the JavaScript programs encountered, from the local server on the card. Thus, the customisation programs stored in the card in the form of JavaScript programs are mixed with the code of the application in the browser. Said JavaScript programs are then executed for example by including the following directive in the page of the application. It should be noted that the JavaScript functions supplied as customisation programs by the local server integrated into the card can be executed by any other means enabling Javascript programs to be executed within an HTML page, such as on reaction to an event (a click by the user, the mouse of the user passing over an element of the HTML page, etc.).

...
<body... onload=“personalize ( ) ”... >
...

It should be noted that the abovementioned JavaScript programs can, as in the case of the previously described UserScripts, send requests to the Web server of the card for dynamically recovering the customisation data belonging to the user, which are used for carrying out the customisation of the page. All of the operations involving the card of the user (downloading of JavaScript customisation, programs, request to customisation data) can be secured via authentication of the user.

A more limited way of carrying out customisation in the browser simply consists of including in the JavaScript programs supplied by the application itself requests (for example via XMLHttpRequest) to the Web server of the card for dynamically recovering the customisation data belonging to the user, which are used for carrying out customisation of the page.

In the example of embodiment described here, there is nevertheless a difficulty to overcome concerning the “cross-domain security policy” of browsers. It is advisable to note that the UserScripts used in the preceding example of embodiment are not subjected to said cross-domain security policy. Said policy establishes that the JavaScript programs of an HTML page can only originate from the same server as the server which served the page itself. Likewise, XMLHttpRequest requests can only be intended for the server which served the page. The embodiment such as described here for mixing the applications and the customisation must therefore overcome said problems in order to be implemented. Various solutions (combinable) are envisageable and are listed hereafter.

Thus, certain browsers, such as Internet Explorer, authorise said policy to be configured by the user. The configuration may be based on the address of the remote server site, upon an explicit request each time that said scenario arises (with possibility of authorising until further notice), or on the presentation of certificates. For example, the pages of the domain corresponding to the address of the remote server site supplying the application may be authorised to load the JavaScript programs of the card of the user and to send XMLHttpRequest requests to the card of the user.

Moreover, a upgrade of the browsers could authorise the card itself to supply or not said JavaScript programs or to respond to the XMLHttpRequest requests according to the origin of the page, the certificates thereof, or even according to an authentication procedure between the card and the remote server (via the browser or directly between the card and the remote server via the Internet), in order to establish or not the confidence.

The cross-domain security policy not being currently standardized, all of said solutions are envisageable, each browser being able to choose to install the policy that it desires. In addition, the card of the user could be considered as a specific domain by the browser, which, in relation to same, would not have such a prohibitive policy. Finally, the “tailor-made” browsers supplied for example by a mobile telephone operator in the telephones thereof, could be designed specifically for authorising the mixing between the application originating from the site of the operator (and the affiliates thereof) and the customisation programs originating from the SIM card of the user (which moreover is also supplied by the operator). Finally, another solution to said problem is to have both the Web application and the customisation served by the local server integrated into the card of the user, as will be described hereafter.

Said last example of embodiment is equivalent to the preceding embodiment with the difference that the Web application is this time served by the card itself rather than by a remote server. All of the other features of the preceding example of embodiment are unchanged. The interest of said approach is thus to make the Web application always available, even when the browser of the user is not connected to the Internet. The other interest, is that cross-domain security policy problems no longer exist since all of the parts of the application, including the customisation thereof, are supplied by the same server, i.e. the card.

The decoupling is indeed maintained between the application and the customisation thereof, since same are always separate programs and data which are mixed in the browser of the host terminal, this unburdening the application server, i.e. the card in said example of embodiment, of said work, and always enabling customisation of the application to be changed independently.

Finally, in said last example of embodiment, it could be envisaged that the entire application is not served by the local server of the card of the user, but only a minimum part of same enabling same to work offline (without all of the functionalities). When the connection is established, the additional parts of the application (upgrading same) are downloaded from a remote server and mixed in the browser in the same way as in the preceding example where the application and the customisation were mixed (with the same cross-domain security problems and similar solutions).

1. A method for customising a Web application, executed on a terminal of a user by means of a browser which is provided on the terminal, upon a request sent via a telecommunication network from the browser to a remote Web server hosting the application, comprising:
hosting at least one customisation program and/or customisation data by a local server belonging to the user associated with the terminal, and
implementing the customisation of the application by mixing the customisation program and/or customisation data supplied by the local server with the data relating to the application corresponding to the processing of the request supplied by the remote server.

2. A method according to claim 1, wherein said local server belonging to the user is produced in the form of a Web server embedded in a portable digital device connected to the terminal of the user.

3. A method according to claim 1, wherein said local server belonging to the user is installed on the terminal of the user.

4. A method according to claim 1, wherein said step for mixing the data relating to the Web application with the customisation program and/or the customisation data is performed in the browser of the terminal of the user on which the application is executed.

5. A method according to claim 4, wherein said mixing step comprises:
prior recovery by the browser of the data relating to the application corresponding to the processing of the request sent to the remote server,
execution by the browser of customisation operations corresponding to the customisation program and/or to the customisation data accessed upon a request at the local server belonging to the user, and
interpretation by the browser of the results of the customisation operations for integrating said results into the data relating to the application.

6. A method according to claim 1, wherein said step for mixing the data relating to the Web application with the customisation program and the customisation data is performed in the remote server.

7. A method according to claim 6, wherein said mixing step comprises:
supply by the remote server to the local server of data relating to the application corresponding to the processing of the request sent by the browser to the remote server,
execution by the local server of customisation operations upon a request by the remote server, and
interpretation by the server of the results of the customisation operations for the integration thereof with the data relating to the application to be supplied to the browser of the terminal of the user.

8. A method according to claim 1, wherein access to the customisation data and/or program(s) on the local server is secure.

9. A method according to claim 8, wherein securing of the access to the local server comprises authentication of the user.

10. A system for customising a Web application, comprising a terminal ) of a user equipped with a browser comprising means for sending a request according to a data transfer protocol to a remote server hosting the application and means for receiving and executing on the terminal of the user the result of the processing of the request by the remote server, said system including a local server belonging to the user associated with the terminal, hosting at least one program for customising the application and/or data for customising the application, and means for mixing the Web application supplied by the remote server with the customisation program and/or the customisation data hosted on the local server belonging to the user.

11. A system according to claim 10, wherein said mixing means are integrated into the browser of the terminal.

12. A system according to claim 10, wherein said the mixing means are integrated into the remote server.

13. A system according to claim 10, wherein the local server comprises a Web server embedded on a portable digital device connected to the terminal of the user.

14. A system according to claim 13, wherein the portable digital device comprises means for securing access to the program(s) and/or data hosted by the embedded server.

15. A system according to claim 14, wherein the portable digital device is a smart card.

16. A portable digital device comprising an integrated Web server for communicating with a client according to a data transfer protocol, wherein the integrated server hosts at least one program and/or customisation data of an application hosted by a remote applications server and comprises means for providing an access to the customisation data and/or program(s) of the application upon a request from the client.

17. A device according to claim 16, wherein the integrated server communicates with a browser of a terminal of a user acting as a client, by means of which the application is executed on the terminal of the user.

18. A device according to claim 16, further comprising means for securing access to the customisation data and/or program(s) of the application.

19. A device according to claim 16, wherein said device is a smart card.
